(19) United States
(12) Patent Application Publication
(10) Pub. No.: US 2024/0211552 A1
(43) Pub. Date: Jun. 27, 2024

(54) System and Methods for Asset Management

(71) Applicant: Zhong Li, Short Hills, NJ (US)

(72) Inventor: Zhong Li, Short Hills, NJ (US)

(21) Appl. No.: 18/291,748

(22) PCT Filed: Jun. 25, 2022
(86) PCT No.: PCT/US22/35037

§ 371 Date: Jan. 24, 2024

(51) Int. Cl. G06F 21/16; H04L 9/32

(52) U.S. Cl. CPC G06F 21/16; H04L 9/3242; G06Q 2220/16

(57) ABSTRACT

In summary, the present invention, in some embodiments thereof, relates to digital and physical assets security and, more specifically, but not exclusively, to systems and methods for registration, validation, and distribution of assets digitally. The invention describes a system and method to establish an asset management system that registers, hosts, and validates submitted digital assets or digital representations of physical assets using cryptographically secured assets, such as digital non-fungible tokens (NFTs).

### FIELD OF THE DISCLOSURE

The present invention, in some embodiments thereof, relates to digital and physical assets security and, more specifically, but not exclusively, to systems and methods for registration and validation of digital non-fungible assets mapped to digital or physical assets and the creation of updated asset representations.

### BACKGROUND OF THE INVENTION

The present teachings are predicated upon systems and methods for cryptographically secured digital non-fungible tokens. The popularity of non-fungible token NFTs continues to grow and get accepted in the marketplace. Fungible tokens can be replaced by an identical token and can therefore be exchanged with any other item that corresponds to its value. One good example is the bitcoin cryptocurrency: you can freely divide each bitcoin into smaller fragments (i.e., “satoshis”) and you can exchange one bitcoin for other (crypto)currencies, usually through the services of an intermediary. Conversely, non-fungible tokens are intended to constitute non-divisible tokens, unique and distinguishable representations of a digital or physical asset (e.g., an artwork or a house). In other words, you cannot interchange one NFT with another NFT, nor can you sell parts of it.

In a non-limiting embodiment, non-fungible tokens (NFTs) are cryptographic assets with unique identifiers and metadata. They are linked in a blockchain thus each NFT is supposed to be immutable and non-interchangeable. As such, non-fungible tokens are units of data on a digital ledger (blockchain), where each NFT can represent a unique digital item. Therefore, for NFTs to perform their intended function, they require a blockchain-based system. This system provides the technical environment that allows NFT transactions to take place securely. In practice, NFTs are first “minted”, meaning that they are created or generated, and such act is recorded on a blockchain. They can then be the object of transactions, usually using the services of specific intermediaries. All these subsequent transactions for an NFT are all recorded on the same distributed ledger or blockchain, typically signaling the respective ownership of the token in question. It is usually the case that if NFT X is minted through intermediary Y on blockchain Z, then transactions for X will take place exclusively on Z

NFTs have been used to commodify digital creations, such as digital art, video game items, and music files among others. NFTs have also functioned as digital collectibles. There are other potential use cases for NFT. For example, it can be used to digitally represent physical assets like artwork. It may also enable the tokenization of a physical asset so that fractional ownership can be maintained and tracked while maintaining the integrity of the physical asset. Preferably but not always, a non-fungible token (NFT) represents something unique, often a one-of-a-kind or limited-edition digital work of art. Presently, enthusiasts are buying these NFTs for obscene amounts of money and storing them in a Web3 Wallet (in the ethereum blockchain).

Despite the fanfare around NFT, it has a major weakness: one could not store the actual digital asset in a NFT because of technical limits of blockchain. As a result, a NFT usually contains a link to a digital asset it represents. This weakness leads to two issues. First, if the link to the digital asset is subsequently changed, the NFT for that digital asset is no longer valid and becomes worthless. This issue may be addressed with centralized servers or hosted using a peer-to-peer file storage system. Each solution has its own issues. Second, because what a buyer purchases is the NFT but not the digital asset it represents, anyone other than the owner or creator of a digital asset can generate a NFT, claim to be the owner or creator of the digital asset, and sell it to an unsuspecting buyer. This fraudulent activity not only hurts buyers and robs the economic benefit from the creator, but also violates the copyright of the creator of digital assets. In another word, although a NFT is unique and non-fungible, and a digital or physical asset has clear ownership, the coupling between a NFT and the asset it represents is weak and can be disrupted or circumvented by unforeseen events or con artists. There is a need to protect the copyright of the creators of digital art and to establish a traceable distribution system to ensure legitimate purchase of digital art or other digital assets.

Digital assets such as digital pictures, digital videos, and ebooks are easily copied and distributed. As a result, courts have so far refused to recognize the “digital first sale” doctrine. However, if individual copies of a digital asset are non-fungible, the “digital first sale” doctrine may be a reality. A copy or an almost identical representation of a digital asset with an embedded NFT becomes non-fungible and traceable as long as the embedded NFT can be extracted and validated. As a result, an artist can issue a set of NFTs to create a corresponding set of distributable and non-fungible copies of his/her digital art while retaining the copyright of the original digital art. Those non-fungible copies can be traded following the “first sale” doctrine.

### SUMMARY

The following summary is an explanation of some of the general inventive steps for the system, method, architecture and apparatus in the description. This summary is not an extensive overview of the invention and does not intend to limit the scope beyond what is described and claimed as a summary.

In summary, the present invention, in some embodiments thereof, relates to digital and physical assets security and, more specifically, but not exclusively, to systems and methods for registration, validation, and distribution of assets digitally. The invention describes a system and method to establish an asset management system that registers, hosts, and validates submitted digital assets or digital representations of physical assets using cryptographically secured assets, such as digital non-fungible tokens (NFTs).

Furthermore, this invention in some aspects describes a system and method that is comprised of the following: establishing a digital representation of copyright or ownership right for digital or physical assets using a cryptographically secured asset, embedding a cryptographically secured asset in representation of digital asset or digital representation of physical asset, establishing a digital representation of distribution right for digital or physical assets using the cryptographically secured asset, embedding the cryptographically secured asset representing distribution right in representation of digital asset or digital representation of physical asset, establishing a digital representation of tokenized ownership of digital or physical asset, and embedding cryptographically secured asset representing tokenized ownership in representation of digital asset or digital representation of physical asset.

In one embodiment, the system enables the upload of a digital asset. Subsequently, a cryptographically secured asset that is a representative of the uploaded digital asset is generated and stored in a blockchain network. The said cryptographically secured asset may represent one or more properties, such as but not limited to rights of the uploaded digital asset. The rights may be indicative of ownership, tokenized ownership, copyright, distribution right, or others. The rights may be restricted by law, countries, geographical regions, income, culture, religion, or time. Properties of the digital asset, such as the date/time of the upload, information on the digital asset, information on the creator/owner, information on rights, may be associated with the said cryptographically secured asset. The uploaded digital asset may be transformed into an updated digital asset with the cryptographically secured asset or a representation of the cryptographically secured asset. The transformation may be driven by a computer algorithm. The transformation may not be detectable by the naked eyes. The presence of the cryptographically secured asset embedded in the updated digital asset may be detected and validated by computer algorithm. The updated digital asset may serve as a proof of ownership of one or more rights. The cryptographically secured assets representing the uploaded digital asset may be structured. In one embodiment, one cryptographically secured asset may contain information of another cryptographically secured asset. The structure may be detected and validated by a computer algorithm.

In one embodiment, the system enables the upload of a digital representation of a physical asset. Subsequently, a cryptographically secured asset that is a representative of the uploaded digital representation of the physical asset is generated and stored in a blockchain network. The said cryptographically secured asset may represent one or more properties, such as rights, of the physical asset. The right may be indicative of ownership, tokenized ownership, copyright, distribution right, or others. The rights may be restricted by law, countries, geographical regions, income, culture, religion, or time. Properties of the physical asset, such as the date/time of the upload of its digital representation, information on the physical asset, information on the creator/owner, information on rights, may be associated with the said cryptographically secured asset. The uploaded digital representation of the physical asset may be transformed into an updated digital representation of the physical asset with the cryptographically secured asset or a representation of the cryptographically secured asset. The transformation may be driven by algorithm. The presence of the cryptographically secured asset embedded in the updated digital representation of the physical asset may be detected and validated by computer algorithm. The updated digital representation of the physical asset may serve as a proof of ownership of one or more rights. The cryptographically secured assets representing the uploaded digital representation of the physical asset may be structured. In one embodiment, one cryptographically secured asset may contain information of another cryptographically secured asset. The structure may be detected and validated by a computer algorithm.

In one embodiment, a cryptographically secured asset is a non-fungible token.

In another embodiment, a cryptographically secured asset is embedded into a digital asset at selected locations using a computer algorithm to produce a updated digital representation of the digital asset.

### BRIEF DESCRIPTION OF FIGURES

The novel features believed to be characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1a of the diagrams is an exemplary illustration of generating a cryptographically secured asset representing the encrypted unique modified copy of a digital asset having a unique watermark.

FIG. 1b of the diagrams is an exemplary illustration of validating a generated cryptographically secured asset representing the encrypted unique modified copy of a digital asset having a unique watermark.

FIG. 2 of the diagrams is an exemplary illustration of generating a plurality of cryptographically secured asset representing the encrypted unique modified copies of a digital asset, each embedded a unique watermark.

FIG. 3a of the diagrams is an exemplary illustration of generating a cryptographically secured asset representing the decrypted unique modified copy of a digital asset having a unique watermark, and embedded with a unique watermark.

FIG. 3b of the diagrams is an exemplary illustration of validating a decrypted cryptographically secured asset, representing a decrypted unique modified copy of a digital asset having a unique watermark, and embedded with a unique watermark.

FIG. 4 of the diagrams illustrates the generating of a plurality of cryptographically secured asset representing the encrypted unique modified copies of a digital asset, each embedded a unique watermark.

FIG. 5 of the diagrams illustrates an algorithm for the specifying the generating of a plurality of cryptographically secured asset representing the encrypted unique modified copies of digital assets embedded a unique watermark.

FIG. 6 of the diagrams is a process flow of generating a cryptographically secured asset representing the decrypted unique modified copy of a digital asset having a unique watermark, and embedded with a unique watermark.

FIG. 7 of the diagrams is a process flow of validating a decrypted cryptographically secured asset, representing a decrypted unique modified copy of a digital asset having a unique watermark, and embedded with a unique watermark.

### DETAILED DESCRIPTION

Hereinafter, the preferred embodiment of the present invention will be described in detail with reference to the accompanying drawings. The terminologies or words used in the description and the claims of the present invention should not be interpreted as being limited merely to their common and dictionary meanings. On the contrary, they should be interpreted based on the meanings and concepts of the invention in keeping with the scope of the invention based on the principle that the inventor(s) can appropriately define the terms in order to describe the invention in the best way.

It is to be understood that the form of the invention shown and described herein is to be taken as a preferred embodiment of the present invention, so it does not express the technical spirit and scope of this invention. Accordingly, it should be understood that various changes and modifications may be made to the invention without departing from the spirit and scope thereof.

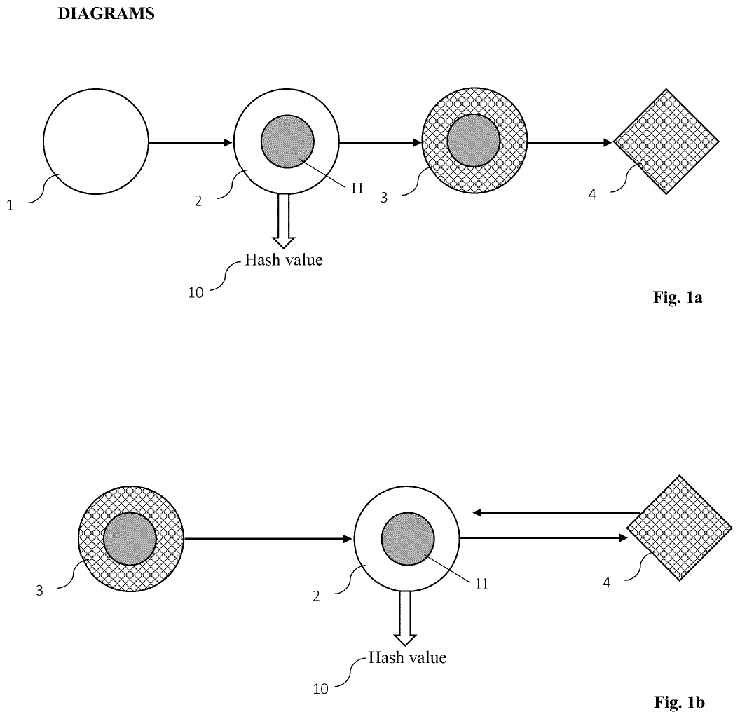

In the first exemplary embodiment according to FIG. 1a of the diagrams is an exemplary illustration of generating a cryptographically secured asset representing the encrypted unique modified copy of a digital asset having a unique watermark. In the diagram is an exemplary digital asset 1, a copy of said asset is represented as 2 in the figure, wherein said copy of digital asset is embedded with a unique watermark 11. A hash value 10 may be obtained from the copy of the digital asset (2) that is embedded with a unique watermark 11. The copy of digital asset is embedded with a unique watermark 11 may be subsequently encrypted, to form an encrypted unique copy of digital asset 2 embedded with a unique watermark, 3. Further, a cryptographically secure asset 4 representing the uniquely watermarked and encrypted copy of the digital asset with obtained hash value is generated, whereby it may be possible to decipher the hash value 10 from said cryptographically secure asset 4.

The digital asset 1 could be a digital representation of a physical asset, a digital asset, a non-fungible token or any such assets that can be represented in a digital format.

In a second exemplary embodiment according to FIG. 1b of the diagrams is an exemplary illustration the validation of an encrypted unique modified copy of a digital asset having a unique watermark represented by a generated cryptographically secured asset. Illustrated on the figure is an encrypted asset 3 which comprises of a copy of a digital asset embedded with a unique watermark. The encrypted asset 3 is decrypted, to obtain unique copy of digital asset 2 embedded with a unique watermark 11, and from which the hash value 10 may be obtained. The obtained hash value 10 may then be validated by comparing it with the hash of the cryptographically secure asset 4 to assert the validity/ownership.

It should be understood that the hash value 10 obtained from an asset modified with a unique watermark may form part of a cryptographically secure asset 4, or may be obtained from it.

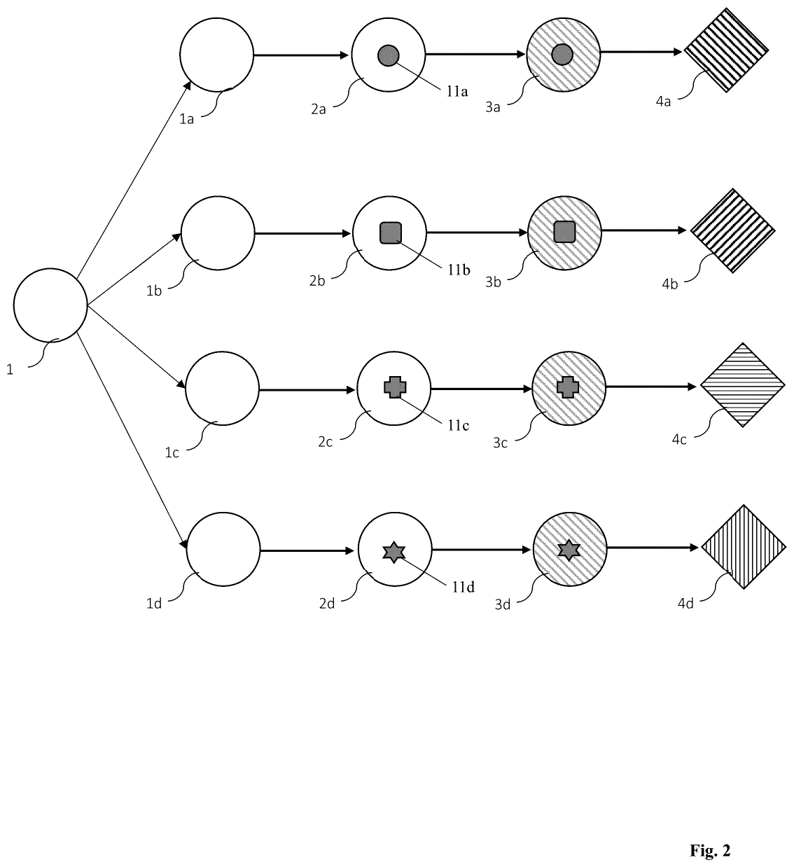

In a further embodiment according to the FIG. 2 of the diagrams is an exemplary illustration of generating a plurality of cryptographically secured assets representing the encrypted unique modified copies of a digital asset, each embedded with a unique watermark. Starting with a digital asset 1, the FIG. 2 teaches of the process of generating copies of a digital asset that can be validated using respective cryptographically secure assets. As an example, a first copy 1a of the digital asset 1 is made, whereby said copy 1a of digital asset is embedded with a unique watermark 11a, to generate a unique first copy 2a of the digital asset 1. A hash value, for instance, 10a may be obtained from the unique first copy 2a of the digital asset 1. Further, the unique first copy 2a of the digital asset 1 may be subsequently encrypted, to form an encrypted asset 3a of the unique first copy 2a of the digital asset 1. Thereafter, a cryptographically secure asset 4a representing the uniquely watermarked and encrypted copy of the digital asset 1 with obtained hash value is generated, whereby it may be possible to decipher the hash value 10a from said cryptographically secure asset 4a.

In another example, a second copy 1b of the digital asset 1 is made, whereby said copy 1b of digital asset is embedded with a unique watermark 11b, to generate a unique second copy 2b of the digital asset 1. A hash value, for instance, 10b may be obtained from the unique second copy 2b of the digital asset 1. Further, the unique second copy 2b of the digital asset 1 may be subsequently encrypted, to form an encrypted asset 3b of the unique second copy 2b of the digital asset 1. Thereafter, a cryptographically secure asset 4b representing the uniquely watermarked and encrypted copy of the digital asset 1 with obtained hash value is generated, whereby it may be possible to decipher the hash value 10b from said cryptographically secure asset 4b.

As a further example, a third copy 1c of the digital asset 1 is made, whereby said copy 1c of digital asset is embedded with a unique watermark 11c, to generate a unique third copy 2c of the digital asset 1. A hash value, for instance, 10c may be obtained from the unique third copy 2c of the digital asset 1. Further, the unique third copy 2c of the digital asset 1 may be subsequently encrypted, to form an encrypted asset 3c of the unique third copy 2c of the digital asset 1. Thereafter, a cryptographically secure asset 4c representing the uniquely watermarked and encrypted copy of the digital asset 1 with obtained hash value is generated, whereby it may be possible to decipher the hash value 10c from said cryptographically secure asset 4c.

Further still, as an example, a fourth copy 1d of the digital asset 1 is made, whereby said copy 1d of digital asset is embedded with a unique watermark 11d, to generate a unique fourth copy 2d of the digital asset 1. A hash value, for instance, 10d may be obtained from the unique fourth copy 2d of the digital asset 1. Further, the unique fourth copy 2d of the digital asset 1 may be subsequently encrypted, to form an encrypted asset 3d of the unique fourth copy 2d of the digital asset 1. Thereafter, a cryptographically secure asset 4d representing the uniquely watermarked and encrypted copy of the digital asset 1 with obtained hash value is generated, whereby it may be possible to decipher the hash value 10d from said cryptographically secure asset 4d.

It should be understood that the exemplary illustration provides for the establishing of a digital representation of copyright or ownership right for digital or physical assets using a cryptographically secured asset, embedding a cryptographically secured asset in representation of digital asset or digital representation of physical asset, establishing a digital representation of distribution right for digital or physical assets using the cryptographically secured asset, embedding the cryptographically secured asset representing distribution right in representation of digital asset or digital representation of physical asset, establishing a digital representation of tokenized ownership of digital or physical asset, and embedding cryptographically secured asset representing tokenized ownership in representation of digital asset or digital representation of physical asset.

Preferably, the exemplary illustration of FIG. 1a, 1b and FIG. 2 are performed by a system that enables the upload of a digital asset. Preferably, the cryptographically secured asset that is a representative of the copy uploaded digital asset is generated and stored in a blockchain network. The said cryptographically secured asset may represent one or more properties, such as but not limited to rights of the uploaded digital asset. The rights may be indicative of ownership, tokenized ownership, copyright, distribution right, or others. The rights may be restricted by law, countries, geographical regions, income, culture, religion, or time. Properties of the digital asset, such as the date/time of the upload, information on the digital asset, information on the creator/owner, information on rights, may be associated with the said cryptographically secured asset.

In some embodiments, the uploaded digital asset may be transformed into an updated digital asset with the cryptographically secured asset or a representation of the cryptographically secured asset. The transformation may be driven by a computer algorithm. The transformation may not be detectable by the naked eyes. The presence of the cryptographically secured asset embedded in the updated digital asset may be detected and validated by computer algorithm. The updated digital asset may serve as a proof of ownership of one or more rights. The cryptographically secured assets representing the uploaded digital asset may be structured. In one embodiment, one cryptographically secured asset may contain information of another cryptographically secured asset. The structure may be detected and validated by a computer algorithm.

In a non-limiting embodiment, the digital asset for which a cryptographically secured asset is generated may embody a digital representation of a physical asset, a digital asset, a non-fungible token or any such assets that can be represented in a digital format.

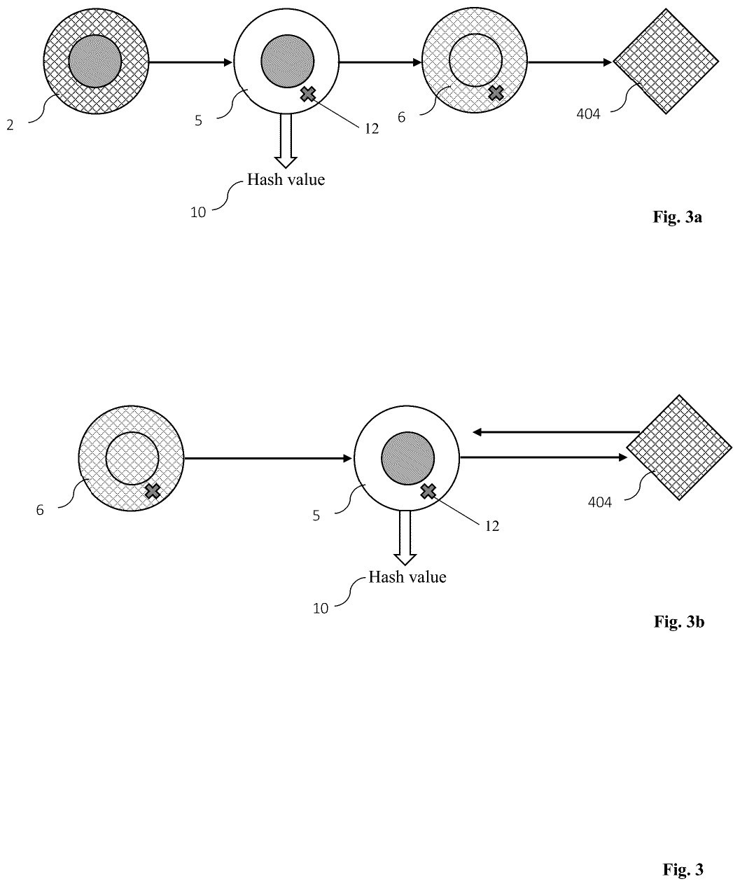

In a subsequent embodiment illustrated by FIG. 3a of the diagrams is an exemplary illustration that teaches of generating a cryptographically secured asset representing the decrypted unique modified copy of a digital asset having a unique watermark, and embedded with a unique watermark. A first encrypted digital asset 2 represented by a first cryptographically secured asset is provided, whereby said encrypted digital asset is decrypted to reveal a decrypted unique modified copy of a first decrypted digital asset embedded with a unique watermark. Thereafter, a unique watermark 12 is embedded onto the decrypted unique modified copy of a first decrypted digital asset embedded with a unique watermark, to generate a unique modified copy of the first decrypted digital asset by embedding a unique watermark in the first decrypted digital asset 5. Thereafter, it is obtained a hash value 10 of the digital asset 5. The subsequent phase in the method is to encrypt the unique modified copy of the first decrypted digital asset embedded with a unique watermark to produce a second encrypted digital asset 6 and store it in a suitable storage device. Finally, we generate a second cryptographically secured asset 404 representing the second encrypted asset and containing the hash value of the unique modified copy of the first decrypted digital asset embedded with a unique watermark and the hash value of the unique watermark.

In a preferred embodiment, the storage device comprises of a blockchain.

In the embodiment exemplified by the FIG. 3b of the diagrams is an illustration of validating a decrypted cryptographically secured asset, representing a decrypted unique modified copy of a digital asset having a unique watermark, and embedded with a unique watermark. The validation begins with an encrypted digital asset 6, which is an encrypted unique modified copy of a first decrypted digital asset embedded with a unique watermark. The said asset is decrypted to reveal an asset 5 with a unique watermark 12 embedded onto a decrypted unique modified copy of a first decrypted digital asset embedded with a unique watermark, and for which a hash value 10 may be obtained. Thereafter, the hash value 10 obtained from the decrypted asset 5 with a unique watermark 12 embedded onto a decrypted unique modified copy of a first decrypted digital asset embedded with a unique watermark is validated from the cryptographically secured asset 404 representing the asset 5 with a unique watermark 12 to asset the authenticity, validity or ownership, wherein the hash value 10 is compared with the hash value contained/that can be obtained in the second cryptographically secured asset.

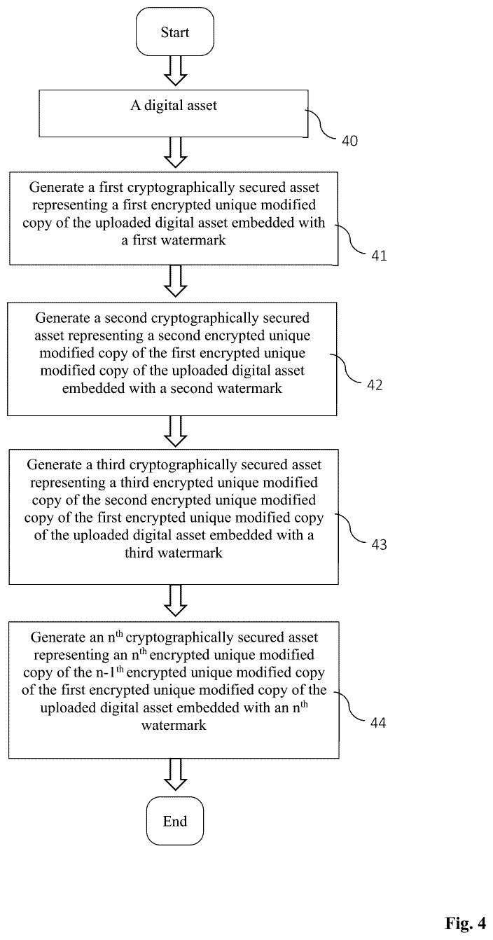

A subsequent embodiment according to FIG. 4 of the diagrams illustrates the generating of a plurality of cryptographically secured asset representing the encrypted unique modified copies of a digital asset, each embedded a unique watermark. The method begins with a digital asset, which may be a digital asset uploaded to a suitably configured system in a step 40. The step 41 is the generation of a first cryptographically secured asset representing a first encrypted unique modified copy of the uploaded digital asset embedded with a first watermark. There is a further subsequent step 42 for generating a second cryptographically secured asset representing a second encrypted unique modified copy of the first encrypted unique modified copy of the uploaded digital asset embedded with a second watermark. The next step 43 entails generating a third cryptographically secured asset representing a third encrypted unique modified copy of the second encrypted unique modified copy of the first encrypted unique modified copy of the uploaded digital asset embedded with a third watermark. A further step 44 involves generating an n^{th} cryptographically secured asset representing an nth encrypted unique modified copy of the n−1^{th} encrypted unique modified copy of the first encrypted unique modified copy of the uploaded digital asset embedded with an n^{th} watermark.

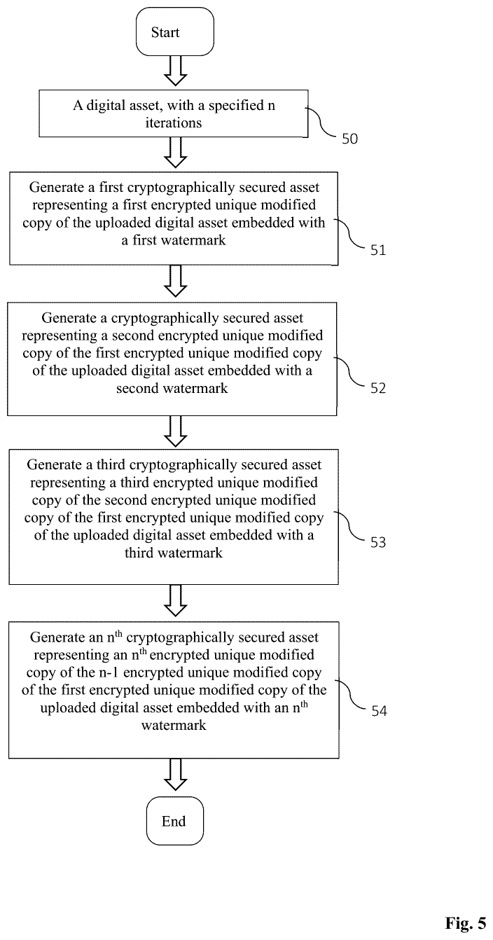

According to an exemplary embodiment as in FIG. 5 of the diagrams, it is illustrated an algorithm for the specifying the generating of a plurality of cryptographically secured asset representing the encrypted unique modified copies of digital assets embedded a unique watermark. The algorithm performs a method beginning with digital asset, for which a specified n iterations is given as in 50. In a step 51, it is generated a first cryptographically secured asset representing a first encrypted unique modified copy of the uploaded digital asset embedded with a first watermark. In a step 52, it is generated a cryptographically secured asset representing a second encrypted unique modified copy of the first encrypted unique modified copy of the uploaded digital asset embedded with a second watermark. In a step 53, it is generated a third cryptographically secured asset representing a third encrypted unique modified copy of the second encrypted unique modified copy of the first encrypted unique modified copy of the uploaded digital asset embedded with a third watermark. In a step 54, it is generated an n^{th} cryptographically secured asset representing an n^{th} encrypted unique modified copy of the n−1 encrypted unique modified copy of the first encrypted unique modified copy of the uploaded digital asset embedded with an n^{th} watermark, where n is the specified number of iterations as provided in 50.

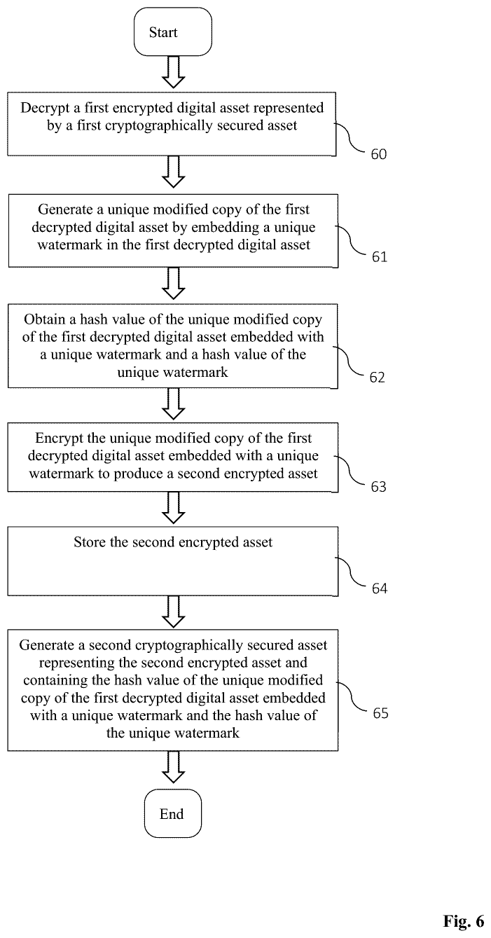

According to an exemplary embodiment as in FIG. 6 of the diagrams is a process flow of generating a cryptographically secured asset representing the decrypted unique modified copy of a digital asset having a unique watermark, and embedded with a unique watermark. The process begins at 60, wherein it is decrypted a first encrypted digital asset represented by a first cryptographically secured asset. In the step 61, it is generated a unique modified copy of the first decrypted digital asset by embedding a unique watermark in the first decrypted digital asset. In the step 62, it is obtained a hash value of the unique modified copy of the first decrypted digital asset embedded with a unique watermark and a hash value of the unique watermark. In the step 63, it is encrypted the unique modified copy of the first decrypted digital asset embedded with a unique watermark to produce a second encrypted asset, which is subsequently stored in a suitable storage device, preferably a blockchain in 64. In 65, it is generated a second cryptographically secured asset representing the second encrypted asset and containing the hash value of the unique modified copy of the first decrypted digital asset embedded with a unique watermark and the hash value of the unique watermark.

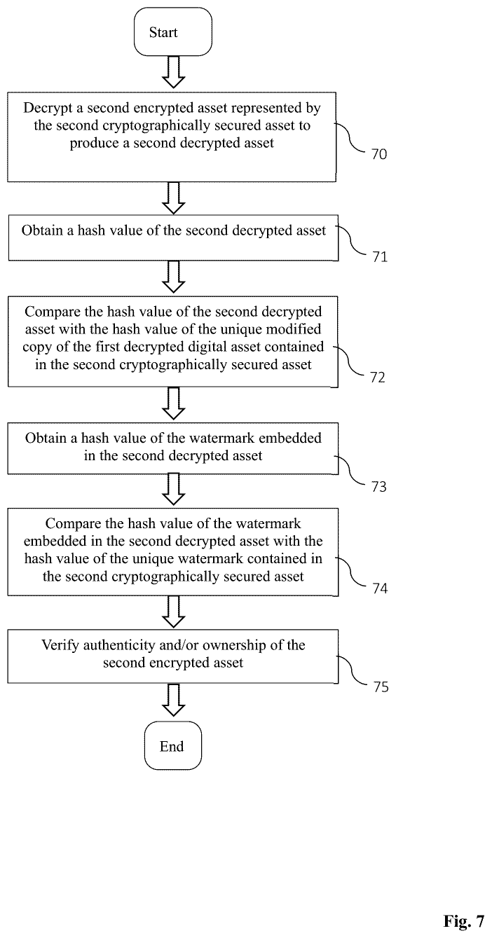

In a last shown exemplary embodiment according to the FIG. 7 of the diagrams is a process flow of validating a decrypted cryptographically secured asset, representing a decrypted unique modified copy of a digital asset having a unique watermark, and embedded with a unique watermark. The process begins at 70, which entails the decryption of a second encrypted asset represented by the second cryptographically secured asset to produce a second decrypted asset. In the step 71, it is obtained a hash value of the second decrypted asset. The step 72 is the comparison of the hash value of the second decrypted asset with the hash value of the unique modified copy of the first decrypted digital asset contained in the second cryptographically secured asset. In the step 73, a hash value of the watermark embedded in the second decrypted asset is obtained. The step 74 is the comparison of the hash value of the watermark embedded in the second decrypted asset with the hash value of the unique watermark contained in the second cryptographically secured asset. Finally, in the step 75, the authenticity and/or ownership of the second encrypted asset is verified.

In some preferred aspects, the digital watermarking techniques described in the present invention may specify the use of imperceptible watermarks embedded in the digital assets. As used herein, an imperceptible watermark may refer to a watermark that is cryptographically embedded within the digital data in such a manner that it is not perceptible to the human eyes, or other senses and cannot be detected or deciphered without specialized algorithms and keys.

Although a preferred embodiment of the present invention has been described for illustrative purposes, those skilled in the art will appreciate that various modifications, additions and substitutions are possible, without departing from the scope and spirit of the invention as disclosed in the accompanying claims.

### INDUSTRIAL APPLICATION

The current invention technology is applicable in the cryptography industry.

What is claimed is:

1. A cryptographic asset management system comprising one or more hardware processors configured by machine-readable instructions to:
receive a digital asset;
generate a copy of received digital asset;
embed a unique watermark on the generated copy of received digital asset using a watermarking algorithm;
obtain a hash value of the generated copy of received digital asset embedded with the unique watermark using a hashing algorithm;
encrypt the generated copy of received digital asset embedded with the unique watermark using an encryption algorithm, and;
generate a cryptographically secured asset representing the encrypted generated copy of received digital asset embedded with the unique watermark, wherein the cryptographically secured asset comprises the hash value obtained from the generated copy of received digital asset embedded with the unique watermark.

2. The system of claim 1, wherein the cryptographically secured asset comprises the cryptographic hash value obtained from the generated copy of received digital asset embedded with the unique watermark.

3. The system of claim 1, wherein the digital asset is a representation of a physical asset.

4. The system of claim 1, wherein the digital asset is a non-fungible token registered on a blockchain.

5. The system of claim 1, further comprising machine-readable instructions to:
receive an encrypted copy of a digital asset embedded with a unique watermark;
decrypt the received encrypted copy of a digital asset embedded with a unique watermark using a decryption algorithm;
obtain a hash value from the decrypted copy of a digital asset embedded with a unique watermark using the hashing algorithm;
compare the obtained hash value with the hash value of the corresponding cryptographically secured asset registered on a blockchain to assert the validity and/or ownership.

6. The system of claim 1, further comprising machine-readable instructions to generate and register a plurality of cryptographically secured assets on a blockchain, each cryptographically secured asset representing an encrypted unique modified copy of the digital asset embedded with a unique watermark.

7. The system of claim 1, further comprising machine-readable instructions to:
receive an encrypted copy of a digital asset embedded with a first unique watermark;
decrypt the received encrypted copy of a digital asset embedded with the first unique watermark using a decryption algorithm;
embed a second unique watermark on the decrypted copy of a digital asset embedded with the first unique watermark using a watermarking algorithm;
obtain a hash value from the decrypted copy of a digital asset embedded with the first and second unique watermark using the hashing algorithm;
encrypt the decrypted copy of a digital asset embedded with the first and second unique watermarks using an encryption algorithm, and;
generate a cryptographically secured asset representing the encrypted decrypted copy of a digital asset embedded with the first and second unique watermarks.

8. The system of claim 7, further comprising machine-readable instructions to:
receive an encrypted decrypted copy of a digital asset embedded with the first and second unique watermarks;
decrypt the received encrypted decrypted copy of a digital asset embedded with the first and second unique watermarks using a decryption algorithm;
obtain a hash value from the decrypted encrypted decrypted copy of a digital asset embedded with the first and second unique watermarks using the hashing algorithm;
compare the obtained hash value with the hash value of a corresponding non-fungible token registered on the blockchain to assert validity and/or ownership.

9. A computer implemented method for generating cryptographically secured assets, the method comprising of:
receiving a digital asset;
generating a copy of received digital asset;
embedding a unique watermark on the generated copy of received digital asset using a watermarking algorithm;
obtaining a cryptographic hash value of the generated copy of received digital asset embedded with the unique watermark;
encrypting the generated copy of received digital asset embedded with a unique watermark using a hashing algorithm;
encrypting the copy embedded with the unique watermark using an encryption algorithm, and;
generating a cryptographically secured asset representing the encrypted generated copy of received digital asset embedded with the unique watermark, wherein the cryptographically secured asset comprises the hash value obtained from the generated copy of received digital asset embedded with the unique watermark.

10. The method of claim 9, wherein the digital asset is a representation of a physical asset.

11. The method as in claim 9, wherein the digital asset is a non-fungible token registered on a blockchain.

12. The method as in claim 9, further comprising:
receiving an encrypted copy of a digital asset embedded with a unique watermark;
decrypting the received encrypted copy of a digital asset embedded with a unique watermark using a decryption algorithm;
obtaining a hash value from the decrypted copy of a digital asset embedded with a unique watermark using the hashing algorithm;
comparing the obtained hash value with the hash value of a corresponding cryptographically secure asset registered on a blockchain to assert the validity and/or ownership.

13. The method of claim 9, further comprising generating and registering a plurality of cryptographically secured assets on a blockchain, each representing an encrypted unique modified copy of the digital asset embedded with a unique watermark.

14. The method of claim 9, further comprising:
receiving an encrypted copy of a digital asset embedded with a first unique watermark;
decrypting the received encrypted copy of a digital asset embedded with a first unique watermark using a decryption algorithm;
embedding a second unique watermark on the decrypted copy of a digital asset embedded with a first unique watermark using a watermarking algorithm;
obtaining a cryptographic hash value from the decrypted copy of a digital asset embedded with the first and second unique watermarks using the hashing algorithm;
encrypting the decrypted copy of a digital asset embedded with the first and second unique watermarks using an encryption algorithm, and;
generating a cryptographically secured asset representing the encrypted decrypted copy of a digital asset embedded with the first and second unique watermarks.

15. The method of claim 14, further comprising:
receiving an encrypted decrypted copy of a digital asset embedded with the first and second unique watermarks;
decrypting the received encrypted decrypted copy of a digital asset embedded with the first and second unique watermarks using a decryption algorithm;
obtaining a hash value from the decrypted encrypted decrypted copy of a digital asset embedded with the first and second unique watermark using the hashing algorithm;
comparing the obtained hash value with the hash value of a corresponding cryptographically secure asset registered on the blockchain to assert validity and/or ownership.
